(19) United States
(12) Patent Application Publication
(10) Pub. No.: US 2007/0158936 A1
(43) Pub. Date: Jul. 12, 2007

(54) Book tag

(75) Inventors: Masayuki Kato, Tokyo (JP); Muneyuki Ishihara, Tokyo (JP)

Correspondence Address: OLIFF & BERRIDGE, PLC, P.O. BOX 19928, ALEXANDRIA, VA, 22320, US

(73) Assignee: CARL MANUFACTURING CO., LTD., TOKYO (JP)

(21) Appl. No.: 11/645,070

(22) Filed: Dec. 26, 2006

(30) Foreign Application Priority Data
Dec. 27, 2005 (JP) 2005-374978

(51) Int. Cl. B42D 1/00

(52) U.S. Cl. 281/21.1

(57) ABSTRACT

There is provided a book tag engageable with and detachable from a ring that binds at least one piece of paper through a plural number of holes made on one side of the paper comprising: a main body, including a first side surface, a second side surface and a connecting portion wherein the first side surface and the second side surface are connected at one end with the connecting portion while the other end, not connected, is opened at an angle between 30 degrees and 150 degrees; and at least one engaging portion, which engages the main body with the ring.

### BACKGROUND OF THE INVENTION

1. Field of the Invention

The present invention relates to a book tag, particularly to a book tag to be engaged with a ring binding book in which a plurality of papers are bound with a ring.

2. Description of the Related Art

Conventionally, a ring binding book, wherein a plurality of papers with holes are bound with a ring, has been used. The ring binding book can be categorized into, for example, a sketchbook, notebook, album or pocketbook. In these ring binding books, each of the papers bound with the ring is rotatable at 360 degrees around the ring, so that the papers can be placed one upon another. Accordingly, these ring binding books are space-saving, handy and easy to be kept

As hereinabove described, the ring binding book has advantage that each paper can be rotated around the ring so that it can be placed one upon another; however, it has been difficult to place a tag on the spine of the book because of the ring. Accordingly, a title needs to be placed on the front cover of the ring biding book; a user selects a desired book according to the title. But, when the ring binding book is stored in a bookshelf or a cabinet, the title on the front cover becomes unseeable, which may hamper the user to find the desired books.

Registered Utility Model No. 3073814 (hereinafter Reference 1) discloses a platy tag placed on a ring provided on the spine of a book. As shown in FIGS. 21 and 22, this platy tag 50 has a plural number of fitting holes 51 engageable with ring 52 wherein the fitting holes 51 are communicated with slits 53 which are formed in a direction that the platy tag 50 is inserted.

The slits 53 have chamfered entrances 54 so that the ring 52 can be smoothly inserted into the fitting holes 51 via the slits 53. The slits 53 can be deformed while the ring 52 passes therethrough, being able to outstretch the chamfered entrances 54. After the ring 52 fits into the fitting holes 51, the slits 53 can back to their original form. The material of the platy tag 50 may be resin or spring steel, having an elastic restoring force.

The platy tag 50 disclosed in the Reference 1 has the following drawbacks. First, because of a platy configuration, the tag 50 may be displaced to the front or the back cover of a book 55 when stored in a bookshelf or a cabinet. This would hamper the function of the tag. Specifically, if the tag 50 is displaced to the front or the back cover, the user cannot identify the contents of the book 55 only by checking the spine of the book 55; the user may need to take out each book 55 from the bookshelf in order to confirm its content until the user finds out a right book.

Further, the platy tag 50 is engaged with the ring 52 in such a manner that the tag 50 is made to project forward relative to the spine of the book 55. See FIG. 22. Accordingly, in case many books 55 are stored in the bookshelf, each side of the tags 50 is arranged parallel to each other, whereby the user cannot identify the title placed on the tag 50 in the front position of the bookshelf. In addition, it may be hard for the user to insert a book between tightly-stored books in the bookshelf.

### SUMMARY OF THE INVENTION

The present invention has been made in light of the problems described above, and it is an object of the present invention to provide a book tag, which enables to engage with a ring or detach from the ring; and to view and confirm the book tag in a front position when a book is stored in a bookshelf or a cabinet.

In order to achieve the object described above, according to an aspect of the present invention, there is provided a book tag engageable with and detachable from a ring that binds at least one piece of paper through a plural number of holes made on one side of the paper comprising: a main body, including a first side surface, a second side surface and a connecting portion wherein the first side surface and the second side surface are connected at one end with the connecting portion while the other end, not connected, is opened at an angle between 30 degrees and 150 degrees; and at least one engaging portion, which engages the main body with the ring.

With the above book tag, because the first side surface and the second side surface is connected with the angle between 30 degrees and 150 degrees, a title indicating the contents of a book can be placed on both side surfaces. Further, when the book is stored in a bookshelf, etc., the book tag is made to project from the book, whereby a user can identify the title from any angles.

In the first aspect of the present invention, the main body of the book tag may have a V-shaped cross section, and the engaging portion is integrally formed at the other end of the first side surface and the second side surface, which has the opened angle. Here, the meaning of “integrally” includes the case that (1) the engaging portion is provided continually fom the first side surface and the second side surface, and (2) the engaging portion is prepared separately from the first side surface and the second side surface, and fixed to the both side surfaces with a given angle.

With the above book tag formed in the V-shaped cross section, the user does not experience difficulties when storing his book in a bookshelf regardless of that the books are tightly arranged in the bookshelf. Furthermore, because of the V-shaped cross section, the lesser material would be needed to make the book tag.

In the first aspect of the present invention, the V-shaped cross section of the book tag may be formed by bending the center of a plate, which has the engaging portion, to have an angle between 30 degrees and 150 degrees. Because the V-shaped cross section is formed by just bending the center of the plate, the manufacturing process of the book tag is very simple.

In the first aspect of the present invention, the main body may have a polygonal cross section, and the engaging portion is provided on the surface, which is not contiguous to the connecting portion. By providing the book tag having the polygonal cross section, the design quality of the book tag can be improved.

In the first aspect of the present invention, the main body may be elastically deformable to flat by compressing the first side surface and the second side surface wherein the both side surfaces rotate around the connecting portion so that the both side surfaces adjoin each other.

With the above book tag whose main body may be elastically deformed to flat, the book tag may be used for a bookmark. Further, since the book tag can be maintained to be flat, the user does not have any hamper to write on the tag.

According to a second aspect of the present invention, there is provided a book tag engageable with and detachable from a ring that binds at least one piece of paper through a plural number of holes made on one side of the paper comprising: a main body in a columnar configuration wherein the cross section of the main body is circular, semi-circular or arcuate; and an engaging portion, which engages the main body with the ring.

With the above book tag whose main body has a circular, semi-circular or arcuate configuration, a title can be indicated on curved surfaces, whereby a user can place the tag in a direction that tile user desires when stored in a bookshelf, etc. Further, when the user tries to find a book by gently touching the spine of the stored books by his or her finger, the finger can slide on the tags with few friction.

According to a third aspect of the present invention, there is provided a book tag engageable with and detachable from a ring that binds at least one piece of paper through a plural number of holes made on one side of the paper comprising: a platy main body; and an engaging portion engaging the main body with the ring wherein a platy surface of the main body is approximately parallel relative to a spine of a closed book.

The book tag of the above can be made in an easy manufacturing process due to the simple structure. Further, because of the platy surface of the main body approximately parallel to the spine of the closed book, it does not occupy many spaces when the book is stored in the bookshelf, etc.

In the first to third aspects of the present invention, the engaging portion may have a projection wherein the projection of one engaging portion is faced with the projection of another engaging portion. Because of this structure, the engaging portion can hang on a ring from the upper and lower sides, so that the engaging portion can fix to the ring more tightly. Further, by arranging the interval of the projection between one engaging portion and another engaging portion, the tag can be applied to many types of rings having many different pitches.

### BRIEF DESCRIPTION OF THE DRAWINGS

FIG. 1 is a perspective view of a book tag according to a first embodiment of the present invention;

FIG. 2 is a left-side view of a book tag according to a first embodiment of the present invention;

FIG. 3 is a rear view of a book tag according to a first embodiment of the present invention;

FIG. 4 is a bottom view of a book tag according to a first embodiment of the present invention;

FIG. 5 is a main perspective view of a book tag in use according to a first embodiment of the present invention;

FIG. 6 is a top view of a book tag in use according to a first embodiment of the present invention;

FIG. 7 is a perspective view in use wherein a plural number of books are arranged according to a first embodiment of the present invention;

FIG. 8 is a main perspective view wherein a platy book tag is inserted between pages of a book according to a first embodiment of the present invention;

FIG. 9 is a perspective view of a book tag according to a second embodiment of the present invention;

FIG. 10 is a bottom view of a book tag according to a second embodiment of the present invention;

FIG. 11 is a perspective view of a book tag according to a third embodiment of the present invention;

FIG. 12 is a bottom view of a book tag according to a third embodiment of the present invention;

FIG. 13 is a perspective view of a book tag according to a fourth embodiment of the present invention;

FIG. 14 is a perspective view of a book tag according to a fifth embodiment of the present invention;

FIG. 15 is a perspective view of a book tag according to a sixth embodiment of the present invention;

FIG. 16 is a perspective view of a book tag according to a seventh embodiment of the present invention;

FIG. 17 is a perspective view of a book tag according to a seventh embodiment of the present invention;

FIG. 18 is an elevation view showing an engaging portion of a book tag according to an eighth embodiment of the present invention;

FIG. 19 is an elevation view showing another engaging portion of a book tag according to an eighth embodiment of the present invention;

FIG. 20 is an elevation view showing yet another engaging portion of a book tag according to an eighth embodiment of the present invention;

FIG. 21 is a plan view of a conventional book tag; and

FIG. 22 is a main plan view of a conventional book tag in use.

### DETAILED DESCRIPTION OF THE PREFERRED EMBODIMENTS

Preferred embodiments of the present invention will be described with reference to the accompanying drawings. Structure of a book tag, however, is not limited to these embodiments but modifiable if the solution to the conventional problems can be found.

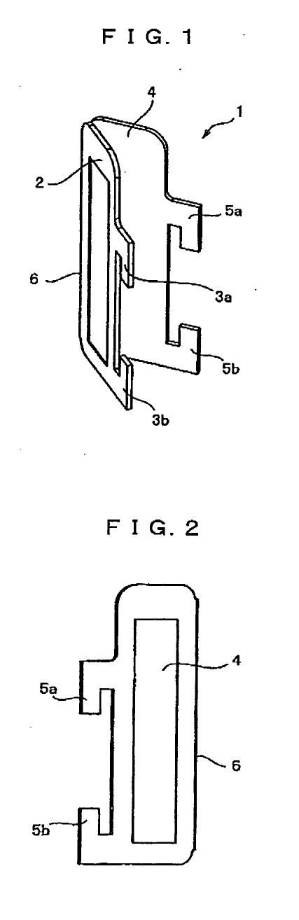

A first embodiment of a book tag will be described hereinbelow with reference to FIGS. 1 to 4. As shown in the figures, the book tag has a first side surface 2, a second side surface 4 and a connecting portion 6 in which the first side surface 2 and the second side surface 4 are connected at the connecting portion 6. On the other side, not connected by the connecting portion (hereinafter refer to non-connected side) is opened at an angle approximately between 30 degrees and 150 degrees (about 30°≦α≦about 150°). In the first embodiment the angle a made by the first side surface 2 and the second side surface 4 is provisionally set to 50°. At the non-connected side, a pair of projections 3a, 3b and a pair of projections 5a, 5b (defined as an engaging portion) are integrally provided on each edge of the side surfaces 2, 4. The projection 3a and the projection 5a face the projection 3b and the projection 5b respectively. Indicate(s) showing contents of a book can be placed on either side surface 2, 4 or both.

The interval between the projection 3a and the projection 3b, and the interval between the projection 5a and the projection 5b are each set in consideration of that the projections can be hung from the upper and lower sides of rings, with some extra space. Because the extra space is given in the intervals, the book tag provided with the projections can be applied to other types of the rings with different pitches.

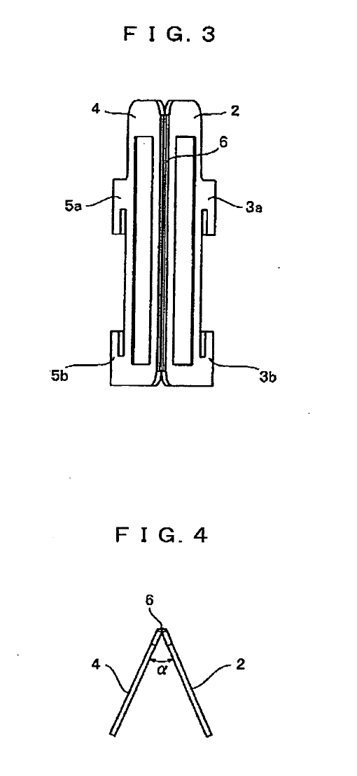

As shown in FIGS. 3 and 4, the first side surface 2 and the second side surface 4 can be folded up inside around the connecting portion 6. The thickness of the connecting portion 6 is made to be thinner than the one of the side surfaces 2 and 4. Specifically, when the thickness of the side surfaces 2 and 4 is set within the range between approximately 0.5 mm and 2.0 mm, it would be preferable to set the thickness of the connecting portion 6 within the range between approximately 0.2 mm to 0.7 mm. By setting the thickness within the range, the connecting portion 6 can retain an elastically restoring force, so that the side surfaces 2 and 4 can restore the original position (opened position) from the folded position.

The material of the book tag 1 may be a plastic thin-plate, a metal plate or a cardboard (such as a plate spring), timber such as bamboo having an elastic force, etc. The book tag can be easily made by placing the engaging portion (a pair of projections) on each edge of the side surfaces 2, 4 (non-connected side) of a plate material with an elastic force. Then, the plate material is folded up in the center thereof, in a longitudinal direction, which forms the connecting portion 6.

Since the book tag 1 is made of the material retaining an elastic force, the first side surface 2 and the second side surface 4 may be pressed and folded up inside around the connecting portion 6, which forms the book tag 1 in flat. Further, by releasing the pressure therefrom, the book tag 1 can be restored to its original form (opened position) with the elastic force of the connecting portion 6.

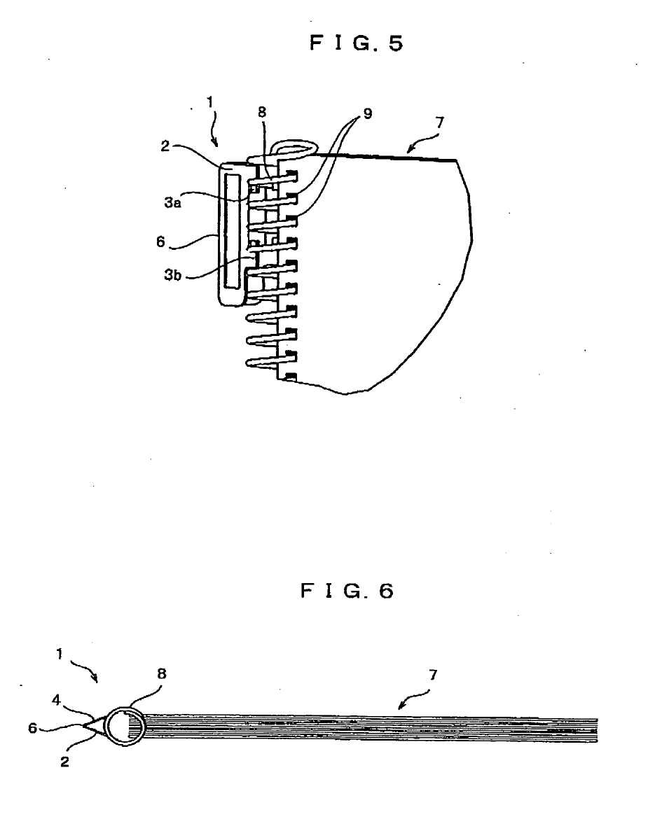

As shown in FIG. 5, by deforming the pair of projections 3a, 3b and the pair of projections 5a, 5b, the projections can be hung onto the ring 8. The book tag 1, which has a V-shaped cross section, functions as a book tag as shown in FIG. 6.

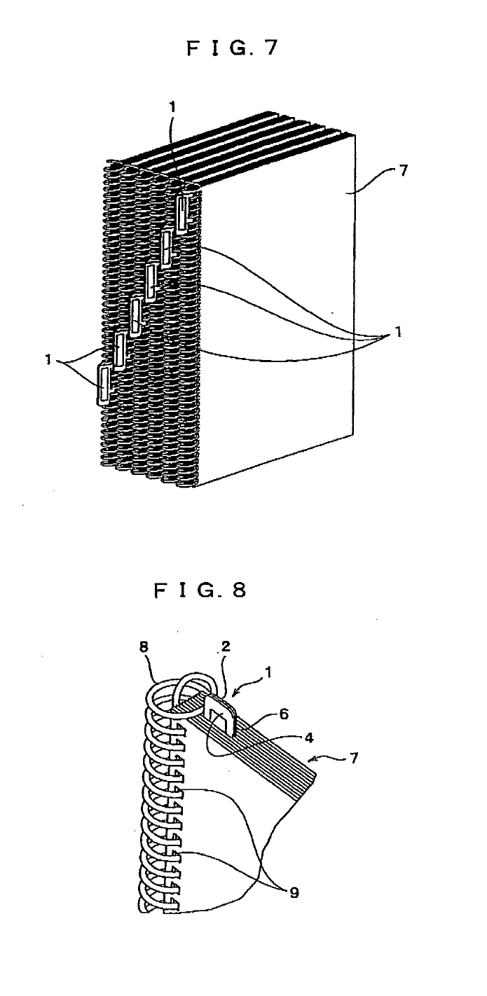

Accordingly, as shown in FIG. 7, even though a plural number of the books 7 are tightly arranged each other, each book tag 1 is made to project relative to the spine of the books 7, whereby user can easily confirm the title placed on the side surfaces 2 and 4 of the book tag 1. Further, each book tag 1 can be placed at any place on the ring(s) 8, improving visibility of the book tag 1. See also FIG. 7.

Further, since the book tag 1 is made to project outward from the spine of the book 7, even if the books were arranged tightly in a bookshelf, user can place a book therebetween without experiencing hamper due to the book tag 1 hung.

Even though each paper of the book 7 is rotatable around the ring 8, and the book tag 1 may be thus squeezed between the paper, the book tag 1 can be elastically deformed to flat by abutting the first side surface 2 and the second side surface 4. With this structure, the book tag 1 would not be any hamper even if the book tag 1 were placed between the paper; the user can even write on the paper with the flat book tag 1 left between the paper. Further, the book tag 1 may be used as a book mark.

When detaching the book tag 1 from the ring 8, the book tag 1 may be slightly twisted relative to the ring 8. By doing so, the book tag 1 can be easily detached from the ring 8. Here, a double-loop ring, a spiral ring, etc. may be applied to the ring 8; the book 7 can be made in such a manner that the ring(s) 8 is engaged with holes 9 provided on the margin of the paper.

The pitch of the ring 8 is varied according to the number of the holes 9 provided. However, the interval between the projection 3a and the projection 3b, and the interval between the projection 5a and the projection 5b are properly determined so as to enable to hold a plural number of rings 8. With this construction, the book tag 1 of the present invention can be applicable to any type of ring 8 with different pitches.

Further, in the book tag 1 of the present invention, the interval between the projections can be further broadened relative to the spine of the book, so that the book tag 1 can be certainly engaged with the ring 8 irrespective of the pitches. The book tag of this type can be manufactured by bending a flat plate with engaging portions or by an integral-molding by die.

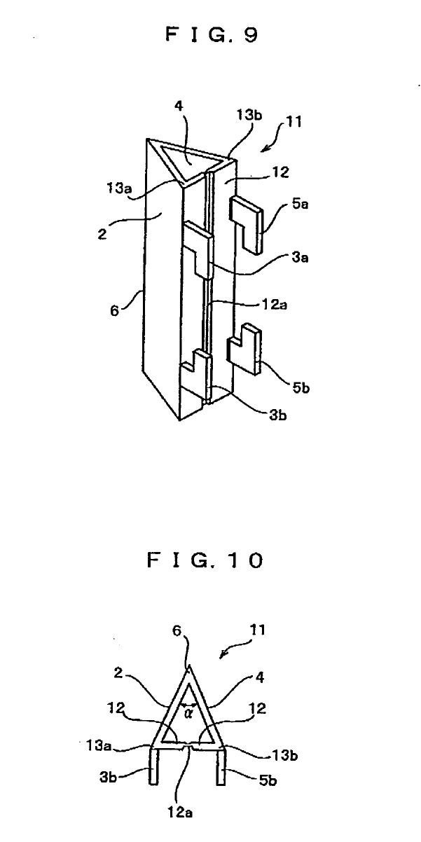

The second embodiment of the present invention will be explained hereinafter with reference to FIGS. 9 and 10. In the second embodiment, a book tag 11 is formed into a hollow triangular-pole. The top surface and the bottom surface of the pole are both opened. Any component parts corresponding to the first embodiment are denoted by the same reference numerals, and a detailed description thereof will be omitted.

As shown in FIGS. 9 and 10, a pair of projections 3a, 3b and a pair of projections 5a, 5b (engaging portion) are formed on each edge of one side surface 12, which is not adjacent to a connecting portion 6. At the center of the one side surface 12, a bending portion 12a, running parallel to the edge of the one side surface 12, is provided.

The bending portion 12a of the book tag 11 can be formed by making the thickness thereof dinner than the rest of the part of the book tag 11. In addition to the bending portion 12a, a bending portion 13a and a bending portion 13b are respectively provided between a first side surface 2 and the one side surface 12, and between a second side surface 4 and the one side surface 12. The bending portions 13a and 13b are fabricated by making the thickness thereof thinner than the rest of the part of the book tag 11. The bending portions 13a and 13b can thus help folding up the one side surface 12 inside toward the connecting portion 6. The one side surface 12 can be of course restorable to its original position.

By pressing the first side surface 2 and the second side surface 4 in a direction that both side surfaces come closer, the bending portion 12a is made to deform outward relative to a spine of a book. The bending portions 13a and 13b then come closer, so that the book tag 11 is deformed to flat.

By releasing the pressure onto the side surfaces 2 and 4, the flat book tag 11 is back to its original shape of the hollow triangular-pole. Further, it would be preferable to adjust height of a pair of projections 3a, 3b and a pair of projection 5a, 5b from the one side surface 12. In this case, when the bending portion 12a formed on the one side surface 12 is made to deform toward the connecting portion 6, the bending portion 12a does not abut to a ring 8 with which the book tag 11 is engaged. Here, it is possible to fabricate the bending portion 12a in such a manner that it is deformed inward relative to the spine of the book, away from the connecting portion 6.

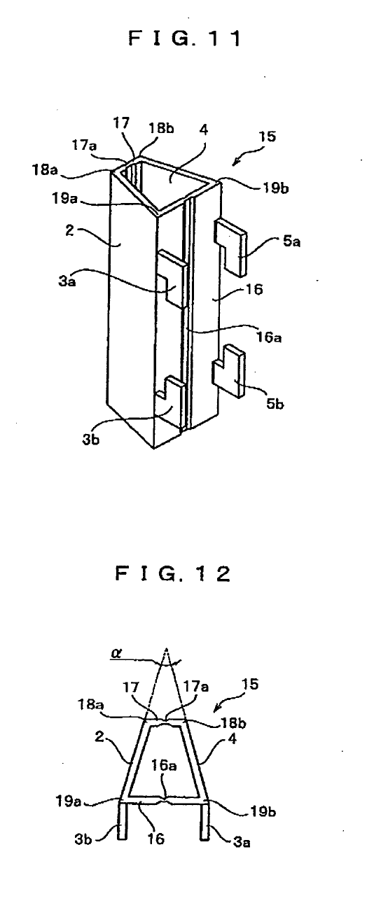

The third embodiment of the present invention will be described hereinafter with reference to FIGS. 11 and 12. A book tag 15 of the third embodiment is formed into a hollow trapezoidal-pole. The top surface and the bottom surface of the pole are both opened. Any component parts corresponding to the embodiments formerly explained are denoted by the same reference numerals, and a detailed description thereof will be omitted.

As shown in FIGS. 11 and 12, a pair of projections 3a, 3b and a pair of projections 5a, 5b (engaging portion) are formed on each edge of one side surface 16 (corresponding to a trapezoidal base). At the center of the one side surface 16, a bending portion 16a running parallel to the edge of the one side surface 16 is provided while at the center of an upper surface 17 (connecting portion), a bending portion 17a running parallel to the edge of the upper surface 17 is also provided.

Further, a bending portion 18a and a bending portion 18b are respectively provided between a first side surface 2 and the upper surface 17, and between a second side surface 4 and the upper surface 17. Still further, a bending portion 19a and a bending portion 19b are respectively provided between the first side surface 2 and the one side surface 16, and between the second side surface 4 and the one side surface 16. These bending portions can be formed by making the thickness thereof thinner than the rest of the part of the book tag 15. Accordingly, these bending portions can be folded up inside or outside relative to a spine of a book (while keeping a restorable character).

By pressing the first side surface 2 and the second side surface 4 in a direction that both side surfaces come closer, the bending portions 16a, 17a are made to deform outward relative to the spine of the book. Each bending portion 18a, 18b, 19a and 19b come closer by the deformation, so that the book tag 15 is deformed to flat. Here, it is possible to fabricate the bending portions 16a and 17a in such a manner that they are deformed inward relative to the spine of the book.

By releasing the pressure onto the side surfaces 2 and 4, the flat book tag 15 is back to its original shape of the hollow trapezoidal-pole. Further, it is preferable that height of a pair of projections 3a, 3b and a pair of projection 5a, 5b from the one side surface 16 is adjusted, so that when the bending portion 16a formed on the one side surface 16 is made to deform toward the connecting portion 17, the bending portion 16a does not abut to a ring 8, with which the book tag 15 is engaged.

Although the book tag 15 with a trapezoidal cross section is discussed, the cross section of the book tag 15 is not limited to the trapezoid. The book tag may have a cross section with pentagon, or more. Although the cross section has more than pentagon, it is still preferable that the book tag retains the deformation character as discussed above.

With the polygonal cross section of the book tag, not only one title but a plural number of titles may be placed on the surfaces. This is going to be more effective if different colors are applied to each polygonal surface, showing different contents thereon.

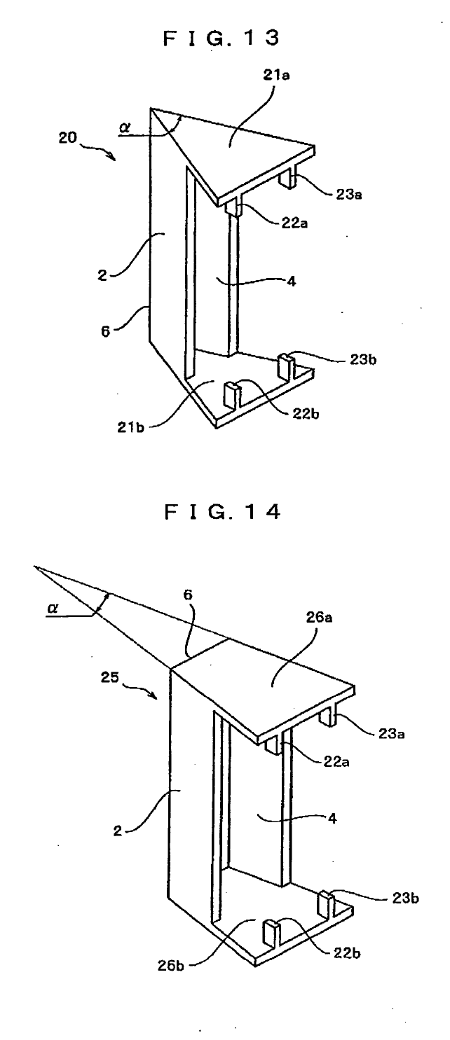

The fourth embodiment of the present invention will be described with reference to FIG. 13. A book tag 20 of the fourth embodiment is formed into a box with top and bottom cover plates. The basic structure thereof is the same with the previously-described first to third embodiments except that the book tag 20 does not have the deformation character but maintains its box shape.

The book tag 20 has side surfaces (first side surface and second side surface) and a pair of projections (engaging portion) enable to engage with a ring or detach from the ring, in the same manner as the former embodiments. These explanations will be thus omitted.

As shown in the figure, the book tag 20 is configured in a box shape with an upper plate 21a and a lower plate 21b, both triangular in shape, and a first side surface 2 and a second side surface 4 connecting the upper and lower plates 21a and 21b. On inner surfaces of the upper plate 21a and the lower plate 21b, a pair of projections 22a, 22b and a pair of projections 23a, 23b are provided. The first side surface 2 and the second side surface 4 are connected with each other by means of a connecting portion 6.

The book tag 20 is used by hanging each projection 22a, 22b, 23a and 23b on a ring 8 of a book 7. In the fourth embodiment, the book tag 20 keeps its box shape, whereby even though a plural number of the books 7 are tightly stored in a bookshelf, etc., the first side surface 2 and the second side surface 4 never come into contact with each other.

The fifth embodiment of the present invention will be described hereinafter with reference to FIG. 14. The fifth embodiment is another embodiment of a book tag of the box shape as explained in the fourth embodiment. Any component parts corresponding to the fourth embodiment are denoted by the same reference numerals, and a detailed description thereof will be omitted.

As shown in FIG. 14, the book tag 25 is configured in a box shape with an upper plate 26a and a lower plate 26b, both trapezoid in shape, and a first side surface 2 and a second side surface 4 connect the upper and lower plates 26a and 26b. On inner surfaces of the upper plate 26a and the lower plate 26b, a pair of projections 22a, 22b and a pair of projections 23a, 23b are provided. The first side surface 2 and the second. side surface 4 are connected with each other by means of a connecting portion 6.

The book tag 25 is used by hanging each projections 22a, 22b, 23a and 23b on a ring 8 of a book 7. In the fifth embodiment, the book tag 25 keeps its box shape, whereby even though a plural number of the books 7 are tightly stored in a bookshelf, etc., the first side surface 2 and the second side surface 4 never come into contact with each other.

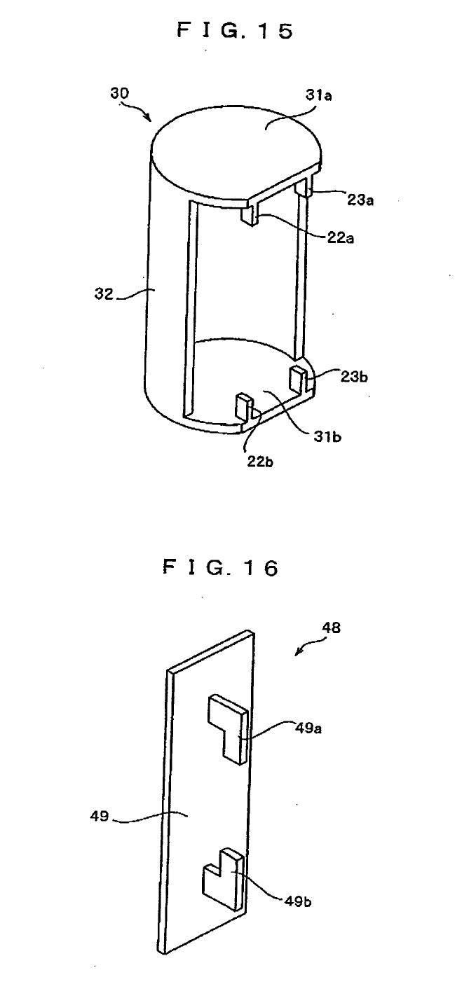

The sixth embodiment of the present invention will be described with reference to FIG. 15. The sixth embodiment is still another embodiment of the box-shaped book tag as explained. The basic structure thereof is the same as the fourth embodiment, whereby any component parts corresponding to the fourth embodiment are denoted by the same reference numerals, and a detailed description thereof will be omitted.

As shown in FIG. 15, the book tag 30 is configured in a box shape with an upper plate 31a and a lower plate 31b, both circular in shape, and a curved side surface 32 connects the upper and lower plates 31a and 31b. On inner surfaces of the upper plate 31a and the lower plate 31b, a pair of projections 22a, 22b and a pair of projections 23a, 23b are provided.

The book tag 30 is used by hanging each projections 22a, 22b, 23a and 23b on a ring 8 of a book 7. In the sixth embodiment, the book tag 30 keeps its box shape, whereby even though a plural number of the books 7 are tightly stored in a bookshelf, etc., the function of the book tag 30 remains without any qualitative deterioration. Further, since the book tag 30 has the curved side surface 32, a title can be placed in a circumferential manner. User can thus check the title in his or her desired angles.

In the embodiments 4 to 6, when engaging the projections 22a, 22b, 23a and 23b with the ring 8, or detaching these projections therefrom, it is possible to deform the projections (either pair or both pairs), or to deform plates (either upper plate or lower plate, or both plates).

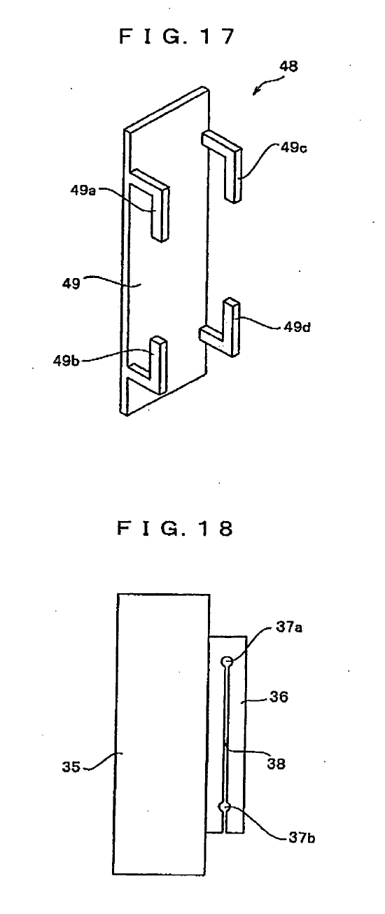

The seventh embodiment of the present invention will be described hereinbelow with reference to FIGS. 16 and 17. A book tag 48 of the seventh embodiment is configured in a platy shape. As shown in FIG. 16, the book tag 48 has a platy body 49. As to an engaging portion, only a pair of the engaging portions can be provided as shown in FIG. 16. Or, two pairs of the engaging portions can be also provided at option as shown in FIG. 17.

The book tag 48 is used by engaging a pair of projection 49a, 49b or two pairs of projections 49a, 49b and 49c, 49d with a ring 8 of a book 7. Since, in the seventh embodiment, the platy book tag 48 can be placed on the ring approximately parallel to the spine of the book 7, it can save space without deteriorating function as a tag. Here, when deciding the lateral width of the platy body 49, some consideration should be given in that the platy book tag 48 should not be interference when opening or closing a book.

In the seventh embodiment, when engaging the projections with the ring 8, or detaching the projections therefrom, these projections (either one pair or two pairs) may be deformed.

The eighth embodiment of the present invention will be described hereinafter with reference to FIGS. 18 to 20. In the eighth embodiment, another type of an engaging portion is explained. The structure of the engaging portion explained hereinbelow is applicable to other embodiments explained hereinabove. FIGS. 18 to 20 are right-side views showing another type of the engaging portion of the book tag.

The book tag shown in FIG. 18 has a flange portion 36 on one side of a side surface 35. A slit 38 is provided on the flange portion 36 in such a manner that the slit 38 is made along a longitudinal direction of the side surface 35. A pair of engaging holes 37a, 37b are provided on the slit 38; one of the engaging holes 37a is provided at the most end of the slit 38 while another engaging hole 37b is provided in midway on the slit 38. The opening of the slit 38 is inserted into the end of a ring 8 as that the pair of the engaging holes 37a, 37b are engaged with the ring 8. The book tag can be placed on the ring 8 in the above-described manner.

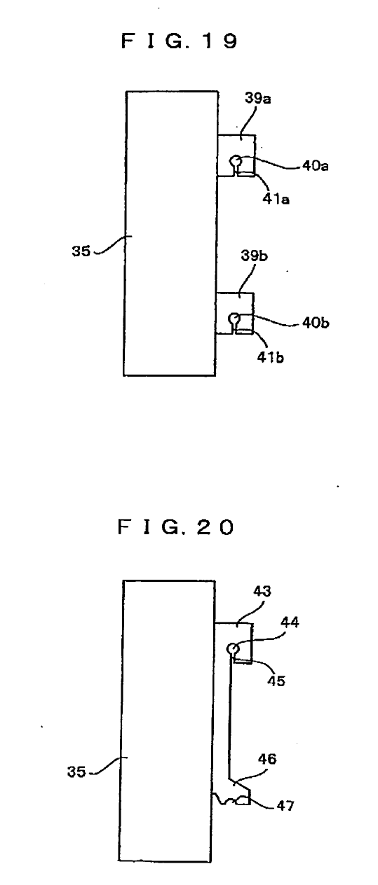

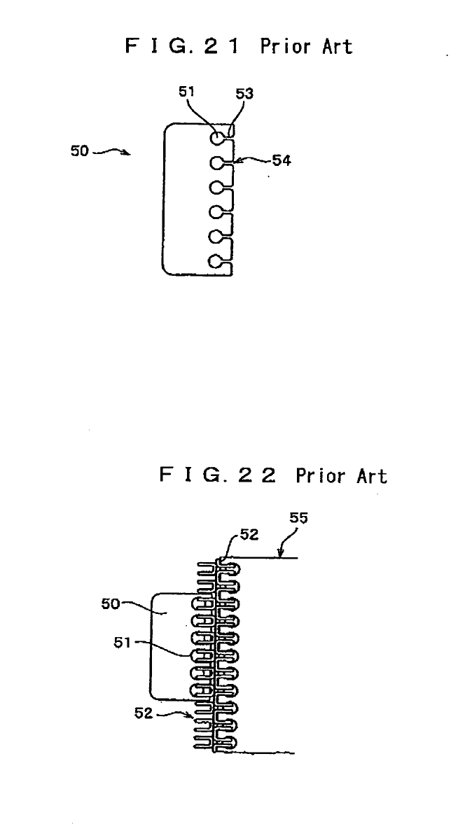

As to a book tag of FIG. 19, a pair of flange portions 39a, 39b are provided on one side of a side surface 35. A slit 41a and a slit 41b are provided on the flange portion 39a and the flange portion 39b respectively. The slit 41a and the slit 41b are provided with an engaging hole 40a and an engaging hole 40b respectively.

Each of the flange portions 39a, 39b is inserted into the ring 8 in such a manner that the ring 8 is introduced into the slits 41a, 41b. Then, the ring 8 is engaged with the engaging holes 40a, 40b so as to place the book tag on the ring 8.

As to the book tag of FIG. 20, a flange portion 43 is provided on one side of a side surface 35. At the upper side of the flange portion 43, a slit 45 and an engaging hole 44 connecting to the slit 45 are provided. Further, at the lower side of the flange portion 43, an engaging section 46 with a concave portion 47 is provided.

A ring 8 is inserted into the slit 45 in such a manner that the ring 8 is engaged with the engaging hole 44 provided on the slit 45. At the same time, the concave portion 47 of the section 46 is also engaged with the ring 8, so that the book tag can be placed on the ring 8. Here, in order to give an elastic deformation effectively to the engaging section 46, it is possible to give some space to the engaging section 46 from that the area nearby the engaging portion 46 is detached from the end of the side surface 35.

As to a main body of a book tag in the present invention, it is possible to form the main body into solid. Further, in case that a ring itself has an elastically deformable character, engaging portions can be made of the material without the deformation character.

1. A book tag engageable with and detachable from a ring that binds at least one piece of paper through a plural number of holes made on one margin of the paper comprising:
a main body, including a first side surface, a second side surface and a connecting portion wherein the first side surface and the second side surface are connected at one end with the connecting portion while the other end, not connected, is opened at an angle between 30 degrees and 150 degrees; and
at least one engaging portion, by which the main body is engaged with the ring.

2. A book tag according to claim 1, wherein the main body has a V-shaped cross section, and the engaging portion is integrally formed at the other end of the first side surface and the second side surface, which has the opened angle.

3. A book tag according to claim 2, wherein the V-shaped cross section is formed by bending the center of a plate with the engaging portion to have an angle between 30 degrees and 150 degrees.

4. A book tag according to claim 1, wherein the main body has a polygonal cross section, and the engaging portion is provided on the surface, which is not contiguous to the connecting portion.

5. A book tag according to claim 1, wherein the main body is elastically deformable to flat by compressing the first side surface and the second side surface to rotate around the connecting portion until the both side surfaces adjoin each other.

6. A book tag engageable with and detachable from a ring that binds at least one piece of paper through a plural number of holes made on one margin of the paper comprising:
a main body in a columnar configuration wherein the cross section of the main body is circular, a semi-circular or arcuate; and
at least one engaging portion, which engages the main body with the ring.

7. A book tag engageable with and detachable from a ring that binds at least one piece of paper through a plural number of holes made on one margin of the paper comprising:
a platy main body; and
an engaging portion engaging the main body with the ring wherein a platy surface of the main body is approximately parallel relative to a spine of a closed book.

8. A book tag according to claim 1, wherein the engaging portion has at least one pair of projections so that each projection of the at least one pair of projections is provided to face each other.

9. A book tag according claim 2, wherein the main body is elastically deformable to flat by compressing the first side surface and the second side surface to rotate around the connecting portion until the both side surfaces adjoin each other.

10. A book tag according claim 3, wherein the main body is elastically deformable to flat by compressing the first side surface and the second side surface to rotate around the connecting portion until the both side surfaces adjoin each other.

11. A book tag according claim 4, wherein the main body is elastically deformable to flat by compressing the first side surface and the second side surface to rotate around the connecting portion until the both side surfaces adjoin each other.

12. A book tag according to claim 2, wherein the engaging portion has at least one pair of projections so that each projection of the at least one pair of projections is provided to face each other.

13. A book tag according to claim 3, wherein the engaging portion has at least one pair of projections so that each projection of the at least one pair of projections is provided to face each other.

14. A book tag according to claim 4, wherein the engaging portion has at least one pair of projections so that each projection of the at least one pair of projections is provided to face each other.

15. A book tag according to claim 5, wherein the engaging portion has at least one pair of projections so that each projection of the at least one pair of projections is provided to face each other.

16. A book tag according to claim 6, wherein the engaging portion has at least one pair of projections so that each projection of the at least one pair of projections is provided to face each other.

17. A book tag according to claim 7, wherein the engaging portion has at least one pair of projections so that each projection of the at least one pair of projections is provided to face each other.

18. A book tag according to claim 9, wherein the engaging portion has at least one pair of projections so that each projection of the at least one pair of projections is provided to face each other.

19. A book tag according to claim 10, wherein the engaging portion has at least one pair of projections so that each projection of the at least one pair of projections is provided to face each other.

20. A book tag according to claim 11, wherein the engaging portion has at least one pair of projections so that each projection of the at least one pair of projections is provided to face each other.
